(19) United States
(12) Patent Application Publication
(10) Pub. No.: US 2009/0009470 A1
(43) Pub. Date: Jan. 8, 2009

(54) WRISTWATCH-TYPE MOBILE TERMINAL HAVING PRESSURE SENSOR AND METHOD FOR RECEIVING USER INPUTS THEREIN

(75) Inventors: Sung-Youl CHOI, Suwon-si (KR); Jin-Choul Lee, Suwon-si (KR); Hyun-Soo Kim, Suwon-si (KR); Kwan-Sic Kim, Yongin-si (KR); Sung-Jin Yoon, Uijeongbu-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 12/166,777

(22) Filed: Jul. 2, 2008

(30) Foreign Application Priority Data
Jul. 3, 2007 (KR) 2007-66592

(51) Int. Cl. G06F 3/033

(52) U.S. Cl. 345/158

(57) ABSTRACT

Disclosed is a wristwatch-type mobile terminal and method for receiving user inputs therein, which can efficiently receive user inputs through a pressure sensor. The method for receiving user inputs in a wristwatch-type mobile terminal includes providing a sensor unit to the wristwatch-type mobile terminal and detecting a user input through the sensor unit, deciding an operation corresponding to a corresponding location of the sensor unit depending on the user input, determining whether the decided operation relates to movement of a pointer movable on a display screen, determining whether pressure of the user input is more than a preset value when the decided operation relates to the movement of the pointer, and moving the pointer a first distance and displaying the pointer when the pressure of the user input is not more than the preset value, or moving the pointer a second distance and displaying the pointer when the pressure of the user input is more than the preset value.

### PRIORITY

This application claims priority under 35 U.S.C. §119(a) to an application filed in the Korean Industrial Property Office on Jul. 3, 2007 and assigned Serial No. 2007-66592, the contents of which are hereby incorporated by reference.

### BACKGROUND OF THE INVENTION

1. Field of the Invention

The present invention relates to a wristwatch-type mobile terminal and a method for receiving user inputs therein, and more particularly to a wristwatch-type mobile terminal and a method which can efficiently receive user inputs through a pressure sensor.

2. Description of the Related Art

Conventional wristwatch-type mobile terminals are generally provided with keys for user inputs arranged on a body thereof. As the wristwatch-type mobile terminals have to be worn around the user's wrist, their bodies are small and light compared with normal mobile terminals. As such, when a key input unit is used by the user to input key data, space is not sufficient for the keys, thus the user cannot comfortably press the keys.

Also, in manufacturing the body of the wristwatch-type mobile terminal, the key input unit should be arranged in the body that is small and light, which is difficult to make. Because the key input unit is arranged on the small body, the key input unit and its buttons have to be small. The small buttons make it difficult for the user to press correctly.

It might be considered to use touch screens for the display screens of the wristwatch-type mobile terminal. However, the small LCDs that have to be used due to the small body of the wristwatch-type mobile terminal would easily bring input errors.

Thus, it is needed a wristwatch-type mobile terminal having an input device that makes the inputs easy and exact.

### SUMMARY OF THE INVENTION

Accordingly, the present invention has been made to solve the above-mentioned problems occurring in the prior art, and the present invention provides a wristwatch-type mobile terminal and method for receiving user inputs therein, which can efficiently receive user inputs.

In accordance with an aspect of the present invention, there is provided a method for receiving user inputs in a wristwatch-type mobile terminal, which includes providing a sensor unit to the wristwatch-type mobile terminal and detecting a user input through the sensor unit; deciding an operation corresponding to a corresponding location of the sensor unit depending on the user input; determining whether the decided operation relates to movement of a pointer movable on a display screen; determining whether pressure of the user input is more than a preset value when the decided operation relates to the movement of the pointer, and moving the pointer a first distance and displaying the pointer when the pressure of the user input is not more than the preset value, or moving the pointer a second distance and displaying the pointer when the pressure of the user input is more than the preset value.

According to another aspect of the present invention, there is provided a method for receiving user inputs in a wristwatch-type mobile terminal, which includes providing a sensor unit including at least one sensor to the wristwatch-type mobile terminal and detecting a user input through one of the at least one sensor; determining whether a sensor receiving the user input is assigned to a hot key; and performing an operation assigned to the hot key when the sensor receiving the user input is assigned to the hot key.

According to another aspect of the present invention, there is provided a wristwatch-type mobile terminal, which includes a sensor unit disposed on a strap associated with a body of the mobile terminal and including at least one sensor, the sensor unit capable of receiving a user input; and a controller deciding an operation corresponding to a corresponding location of the sensor unit depending on the user input, and executing the decided operation.

### BRIEF DESCRIPTION OF THE DRAWINGS

The above and other aspects, features and advantages of the present invention will be more apparent from the following detailed description taken in conjunction with the accompanying drawings, in which:

FIG. 1A is a view of a wristwatch-type mobile terminal according to an embodiment of the present invention;

FIG. 1B is a view of a sensor unit of the wristwatch-type mobile terminal shown in FIG. 1A;

FIG. 2 is a block diagram schematically illustrating a configuration of the wristwatch-type mobile terminal according to an embodiment of the present invention;

FIG. 3 is a view of the sensor unit of the wristwatch-type mobile terminal according to an embodiment of the present invention;

FIG. 4 is a flowchart illustrating a method for receiving user inputs in a wristwatch-type mobile terminal according to an embodiment of the present invention;

FIGS. 5A-5D are examples of the display screen of the wristwatch-type mobile terminal according to an embodiment of the present invention;

FIGS. 6A-6D are examples of a display screen of a wristwatch-type mobile terminal according to an embodiment of the present invention;

FIGS. 7A-7B are examples of a display screen of a wristwatch-type mobile terminal according to an embodiment of the present invention;

FIG. 8 is a view of a sensor unit assigned to hot keys of the wristwatch-type mobile terminal according to an embodiment of the present invention; and

FIG. 9 is a flowchart illustrating a method for receiving user inputs in the sensor unit assigned to hot keys of the wristwatch-type mobile terminal according to an embodiment of the present invention.

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they may be shown in different drawings. In the following description of the present invention, a detailed description of known functions and configurations incorporated herein will be omitted when it may make the subject matter of the present invention rather unclear.

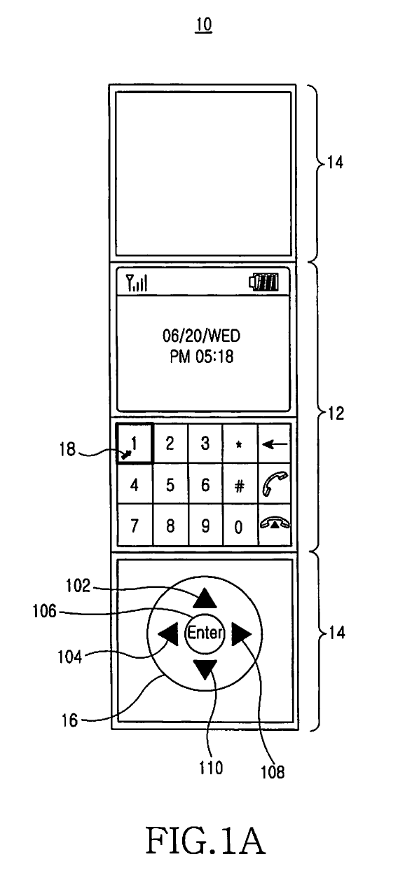

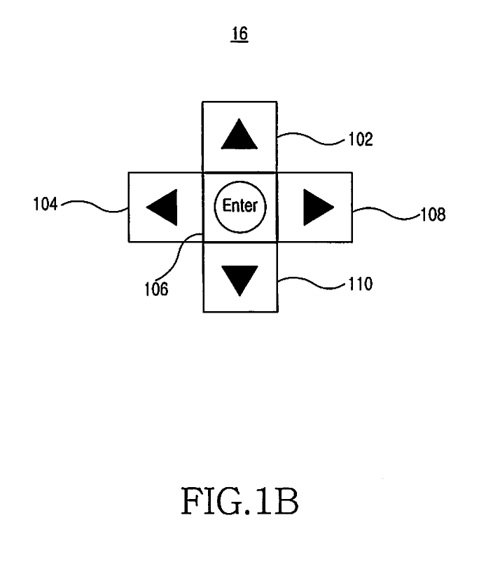

FIG. 1A is a view of a wristwatch-type mobile terminal according to an embodiment of the present invention.

The wristwatch-type mobile terminal 10 includes a body 12, a strap 14, and a sensor unit 16. The wristwatch-type mobile terminal 10 has a construction where the strap 14 is connected to the body 12 and has the sensor unit 16 disposed therein, so that it can receive user inputs.

The body 12 of the wristwatch-type mobile terminal 10 performs all functions in response to user inputs, available in a normal mobile communication terminal such as phone calls, text messages, or multimedia playback. The body 12 can also have a clock function including a display of current time on a display screen, as shown in FIG. 1A.

The wristwatch-type mobile terminal 10 in accordance with this embodiment has no keys on which numerals or characters are marked on the body 12. Thus, the wristwatch-type mobile terminal 10 displays numerals or characters on the display screen, which are selected through the sensor unit 16 by user input.

The sensor unit 16, which may have a circular design as shown in FIG. 1A, displays a movement direction of the pointer 18 to allow the user to recognize the movement of the pointer 18. Also, by receiving an input to select the movement direction displayed in the sensor unit 16, the mobile terminal 10 may convert the display screen.

Although in the embodiment the sensor unit 16 is in a circular shape, the shape is not restricted to being a circle and can be modified by those skilled in the art. The sensor unit 16 can be changed in shape and size without limit, but should be arranged within the area of the strap 14.

The pointer 18 may be referred to as an indicator that is displayed on the display screen to allow the user to easily select characters or numerals. The mobile terminal 10 receives user inputs and moves the pointer 18 on the display screen in response to the received user inputs. The mobile terminal 10 also accepts various command required for executing its functions, such as phone calls, by receiving a user input to confirm a selection of a certain numeral or character where the pointer is placed on.

In FIG. 1A, there are indicators of the sensor unit 16 to make the pointer move on the display screen, in which [symbol] 104 moves the pointer to the left hand side direction of a current position, ‘▴’ 102 to the upward direction, [symbol] 108 to the right hand side direction, and ‘▾’ 110 to the downward direction. An ‘Enter’ button 106 located in the center of the sensor unit 16 is used to input selections of numerals and characters on which the pointer 18 is placed on the display screen.

For example, if the user wants to input ‘1’ where the pointer 18 is currently being placed on as shown in FIG. 1A, he or she needs to press the ‘Enter’ button 106 in the center of the sensor unit 16. Upon receiving the user input of the ‘Enter’ button 106, the mobile terminal 10 displays ‘1’ on the display screen to signify that ‘1’ has been input.

FIG. 1B is a view of the sensor unit of the wristwatch-type mobile terminal shown in FIG. 1A.

FIG. 1B shows the inside of the sensor unit 16 shown in FIG. 1A. The sensor unit 16 may include sensors therein corresponding to the respective indicators, [symbol] 104, ‘▴’ 102, [symbol] 108, and ‘▾’ 110. While the sensor unit 16 shown in FIG. 1A has a circular shape, the inside of the sensor unit 16 may, as can be seen in FIG. 1B, has a shape of a cross with five squares arranged therein.

The number of the sensors provided in the sensor unit 16 may also be easily changed according to other embodiments of the sensor unit 16. Likewise, the shape of the inside of the sensor unit 16 can also be easily changed.

While the drawing shows an example having a plurality of sensors, wherein each sensor corresponds to the associated indicator, the whole sensor unit 16 may be constituted by one sensor.

Referring to FIG. 1B as an example, one sensor may be divided into five parts placed separately, such that each location corresponds to a respective indicator. In this case, when the sensor unit 16 detects a user input, the mobile terminal 10 determines which location corresponds to the part where the user input is detected and decides an operation corresponding to the determined location.

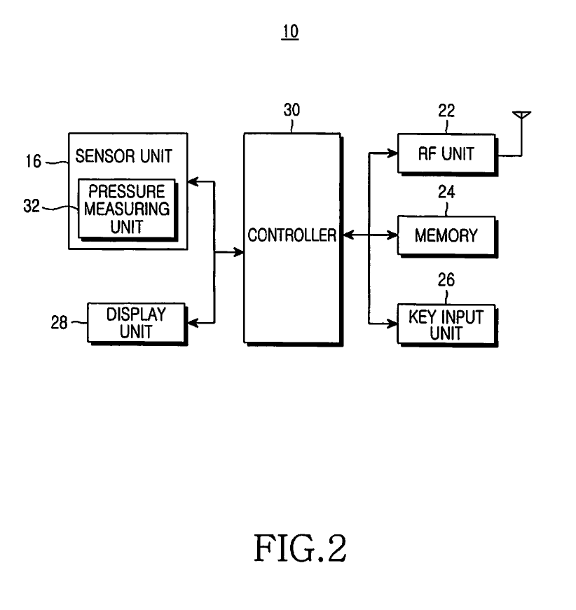

FIG. 2 is a block diagram schematically illustrating a configuration of the wristwatch-type mobile terminal according to an embodiment of the present invention.

The mobile terminal 10 includes an RF (Radio Frequency) unit 22, a memory 24, a key input unit 26, the sensor unit 16, a display unit 28 and a controller 30.

The RF unit 22 performs wireless communication functions of the mobile terminal 10. The RF unit 22 includes an RF transmitter (not shown) for upward converting and amplifying the frequencies of transmission signals and an RF receiver (not shown) for performing low-noise amplifications of received signals and downward conversions of the frequencies of the received signals.

The memory 24 may include a program memory and a data memory and stores various information necessary for operating the mobile terminal 10.

In accordance with this embodiment, the memory 24 stores a preset pressure value for comparison with pressure values measured in a pressure measuring unit 32 described below. The memory 24 may also store movement distance of the pointer 18 moving on the display screen under the control of the controller 30. The pressure value and the movement distance of the pointer 18 may each be a number of values, and may be easily changed by those skilled in the art according to the embodiments of the wristwatch-type mobile terminal of the present invention.

The key input unit 26 is provided with keys used to input numerals and characters and keys used for setting all kinds of functions and receiving inputs of the user.

In accordance with this embodiment, as the mobile terminal 10 receives user inputs of numerals and characters through the sensor unit 16, the key input unit 26 may not be separately included.

The display unit 28 may bean LCD (Liquid Crystal Display), and outputs various display data generated in the mobile terminal 10. If the LCD is a touch screen, the display unit 28 can be used as an input means.

The display unit 28 of this embodiment displays, under control of the controller 30 described below, the movement of the pointer 18 on the display screen that is generated by the user inputs through the sensor unit 16. When receiving a selection input of a certain numeral or character where the pointer is placed on, the display unit 28 may signify that the selected numeral or character has been input by displaying it.

The sensor unit 16 includes a pressure sensor and receives the user inputs. The user input of this embodiment means that the user applies pressure on the sensor unit 16 with his or her finger.

The sensor unit 16 of this embodiment includes the pressure measuring unit 32, and measures the pressure of the user inputs from the sensor unit 16. The pressure sensor may be realized in the form of a capacitor described below. The pressure measuring unit 32 may evaluate the pressure applied to the pressure sensor in proportion to the increase and decrease of the capacity of the capacitor. Also, the sensor unit 16 determines that a certain user input has been made when the capacity of the capacitor increases.

The controller 30 generally controls the operations of the wristwatch-type mobile terminal 10.

The controller 30 of this embodiment receives, through the sensor unit 16, the user inputs and controls the wristwatch-type mobile terminal 10 according to the received user inputs. If a received user input through the sensor unit 16 corresponds to the movement of the pointer 18 displayed on the display screen, the controller 30 determines movement direction of the pointer 18 on the display screen based on the received user input and moves the pointer 18 in a corresponding direction.

The controller 30 compares a pressure value of the user input measured by the pressure measuring unit 32 to the preset pressure value. As a result of the comparison, if the pressure value of the user input is less than the preset pressure value, the controller 30 controls the display unit 28 to move the pointer 18 to a location at a first distance and display it at the location, and if the pressure value of the user input is more than the preset pressure value, the controller 30 controls the display unit 28 to move the pointer 18 to a location at a second distance and display it.

Here, the first and second distances, which are the movement distance of the pointer 18, may be values stored in the memory 24.

While the movement distance of the pointer 18 is described as a first or a second distance in this embodiment, it is not restricted to only two distances. Also, the pressure value applied by the user applies to move the pointer 18 and the pressure value stored for the comparison with the pressure value of the user input may be more than one value.

For example, suppose that the pressure values pre-stored in the memory 24 have four ranges: range A˜B, range B˜C, range C˜D, and range D˜E and the movement distances of the pointer 18 have four values: a, b, c, and d. The controller 30 compares the pressure value of the user input received in the sensor unit 16 with the ranges of pressure values. If the pressure value of the user input received through the sensor unit 16 is in the range of C˜D, the controller 30 moves and displays the pointer 18 to a location at the distance of c.

When receiving the user input of the ‘Enter’ button 106 indicated in the center of the sensor unit 16 shown in FIG. 1A, the controller 30 may display a numeral or character on which the pointer 18 is placed on the display screen to signify that it is selected.

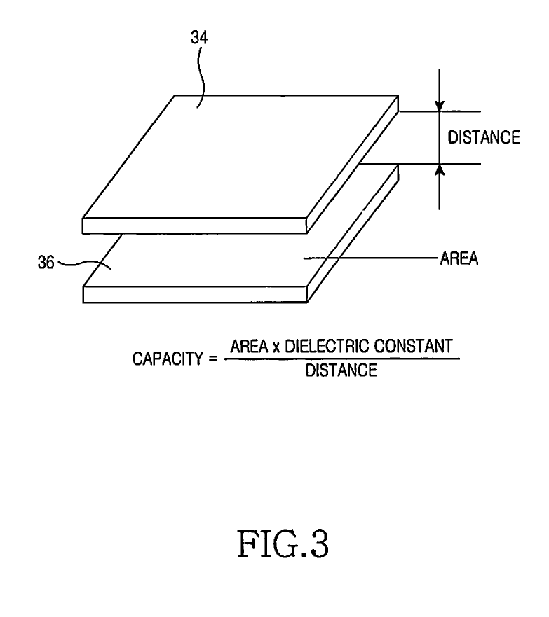

FIG. 3 is a view of the sensor unit of the wristwatch-type mobile terminal according to an embodiment of the present invention.

As shown in FIG. 3, the pressure sensor of the sensor unit 16 can be realized by a capacitor including two substrates oppositely disposed parallel to each other on an upper and a lower sides, respectively. When the user input is received at the sensor unit 16, pressure is applied to the upper substrate 34 of the sensor unit 16. Due to the pressure, the parallel distance between the upper and lower substrates 34 and 36 is shortened. Since the capacity of the capacitor is in proportion to the area and dielectric constant of the substrates and is in inverse proportion to the distance between the substrates, the capacity of the capacitor increases when the pressure applied by the user makes the distance between the substrates is shortened while the user input is being received. Therefore, the sensor unit 16 can detect the user input based on the increase of the capacity of the capacitor. Also, the pressure measuring unit 32 can measure the pressure based on the increase amount of the capacity due to the user input.

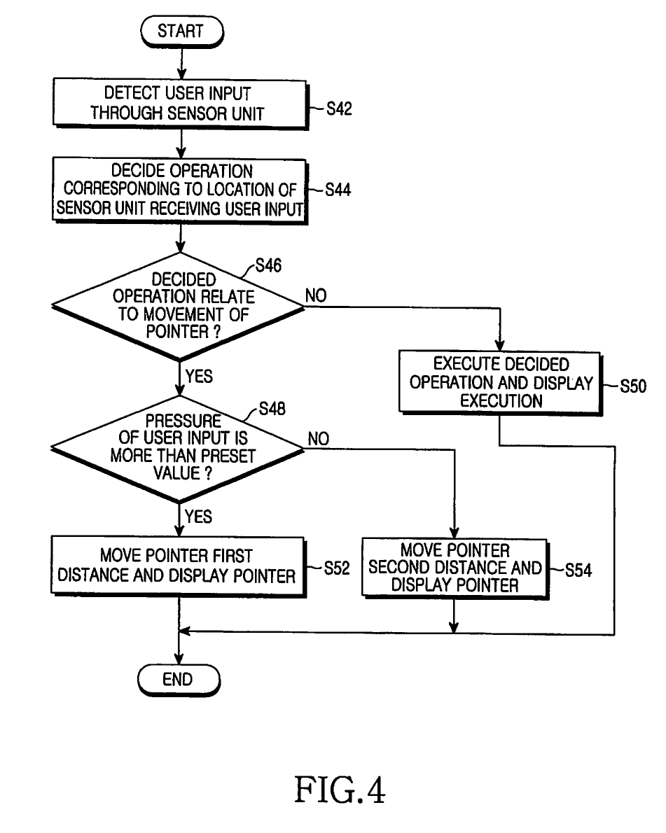

FIG. 4 is a flowchart illustrating a method for receiving user inputs in a wristwatch-type mobile terminal according to an embodiment of the present invention.

The wristwatch-type mobile terminal 10 detects a user input through the sensor unit 16 in step S42. The user input may be performed by the user pressing the pressure sensor included in the sensor unit 16 with his or her finger.

Upon detecting the user input in step S42), the controller 30 decides an operation corresponding to the location of the sensor unit 16 where the user makes an input in step S44.

Referring to the sensor unit 16 shown in FIG. 1A, for example, if the user input is detected through the indicator of [symbol] 104 of the sensor unit 16, the controller 30 decides to move the pointer 18 in the left hand side direction of the current location on the display screen. Likewise, if ‘▴’ 102 is detected, the controller 30 moves the pointer 18 in the upward direction, [symbol] 108 in the right hand side direction, and ‘▾’ 110 in the downward direction. In addition, upon detecting a user input of the ‘Enter’ button 106, the controller 30 determines that the character or numeral that the pointer 18 indicates on the display screen has been selected.

The controller 30 determines if the decided operation in step S44 relates to movement of the pointer 18 in step S46.

As a result of the determination of step S46, if the decided operation does not correspond to the movement of the pointer 18, the controller 30 performs the operation decided in step S44 and displays it on the display unit 28 in step S50.

The operation performed in step S50 corresponds to the case where the user input of the ‘Enter’ button 106 is detected in the sensor unit 16. If the user input of the ‘Enter’ button 106 is received when a numeral or character on the display unit 28 is being selected by the pointer 18, the selected character or numeral is displayed on the display unit 28, and at the same time, is input to the mobile terminal 10. Likewise, if the user input of the ‘Enter’ button 106 is received when a function key such as ‘Call’ is being selected, a call connection can be made.

As a result of the determination in step S46, if the operation decided in step S44 corresponds to the movement of the pointer 18, the controller 30 determines whether pressure of the user input is more than the preset value in step S48.

If the pressure is more than the preset value, the pointer 18 of the display unit 28 is moved and displayed at a location at a first distance in step S52. If the pressure is less than the preset value, the pointer 18 of the display unit 28 is moved and displayed at a location at a second distance in step S54.

The first and second distance, which is the movement distance of the pointer 18, are different from each other, and may be values stored in the memory unit 24.

In steps S52 and S54, the controller 30 controls the display unit 28 to move the pointer 18 the first distance and the second distance for the same period of time, respectively. Thus, if the second distance is greater than the first distance, the user will have a feeling that the pointer 18 in step S54 moves faster. That is, the movement distance of the pointer 18 is different depending on the pressure of the user input, whereby the user can feel that the movement speed of the pointer 18 is different depending on the pressure of the user input.

While the movement distances of the pointer 18 in this embodiment are two distances, the movement distances may be more than two according to the number of the preset pressure values.

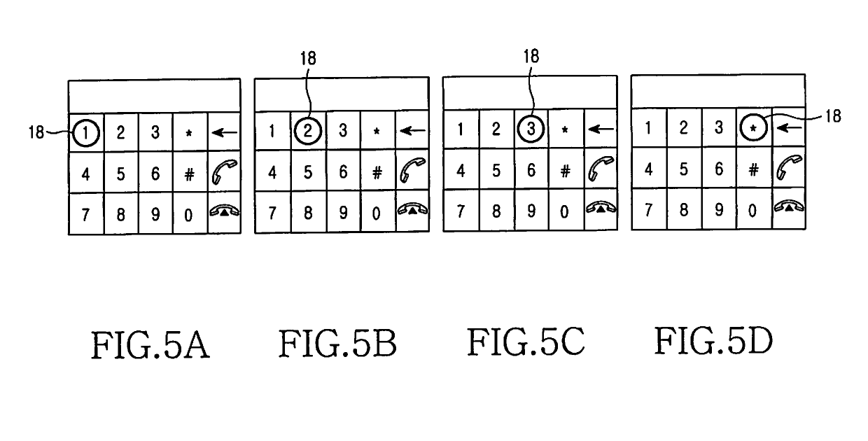

FIGS. 5A-5D are examples of the display screen of the wristwatch-type mobile terminal according to an embodiment of the present invention.

The display screen arranged on the body 12 of the wristwatch-type mobile terminal 10 as shown in FIG. 1A is largely divided into two parts, wherein the current time, etc., may be displayed in the upper part, and the numerals or characters, etc., are displayed in the lower part.

Among those, the numerals or the characters displayed at the lower part of the display screen are shown in FIGS. 5A-5D. The wristwatch-type mobile terminal 10 selects numerals or characters to be displayed on the display screen by receiving, through the sensor unit 16, the user input to move the pointer 18. In FIGS. 5A-5D, numerals 0˜9 and special characters are illustrated on the display screen, which is partitioned into the respective numerals and special characters to distinguish them.

The pointer 18 is illustrated as being in the shape of a circle in FIGS. 5A-5D. The pointer 18 indicates ‘1’ in FIG. 5A, ‘2’ in FIG. 5B, ‘3’ in FIG. 5C, and ‘*’ in FIG. 5D, respectively. The pointer 18 is moved by the user inputs detected in the sensor unit 16.

Referring to FIGS. 5A-5D, the pointer 18 is moved from the left to the right in the sequence of ‘1→2→3→*’. The movement of the pointer 18 is made by the user inputs through the sensor unit 16. In this case, each movement of the pointer 18 is short, because the pressure of the user input is less than the preset value.

The user can move the pointer 18 in the sequence of ‘1→2→3→*’ by continuously applying pressure less than the preset value to the indicator [symbol] of the sensor unit 16. Here, the user inputs to be detected in the sensor unit 16 are continuously made so that all the user inputs are made for a certain period of time. For example, if the certain period of time is 0.5 seconds, the user should apply pressure less than the preset value three times for 0.5 seconds in order to move the pointer 18 in the sequence of ‘1→2→3→*’.

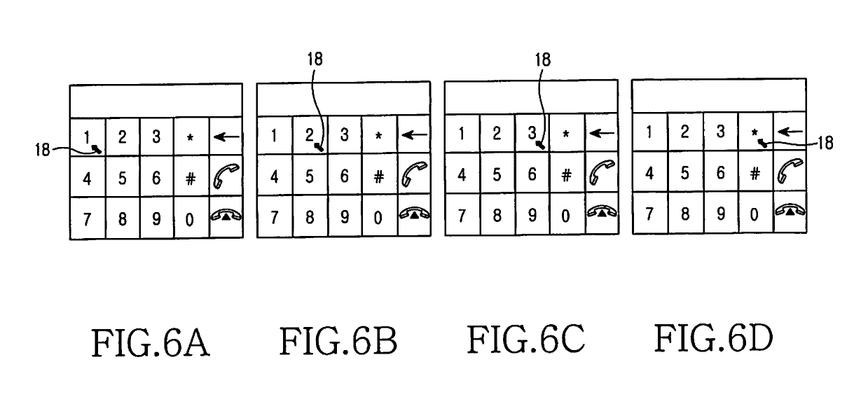

FIGS. 6A-6D are examples of a display screen of a wristwatch-type mobile terminal according to an embodiment of the present invention.

The pointer 18 is illustrated as being in the shape of an arrow in FIGS. 6A-6D. FIGS. 6A-6D illustrate that the pointer 18 is moved when the sensor unit 16 receives user inputs on the indicator [symbol] 104. The user applies pressure less than the preset value to the indicator [symbol] 104, and the controller 30 controls the display unit 28 to move the pointer 18 in a sequence of ‘*→3→2→1’.

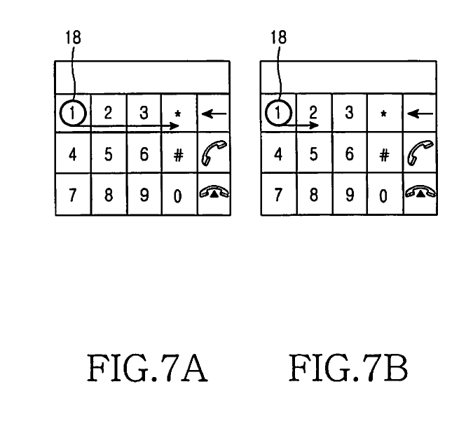

FIGS. 7A-7B are examples of a display screen of a wristwatch-type mobile terminal according to an embodiment of the present invention.

In FIG. 7A, the pointer 18 is moved in a sequence of ‘1→*’ when the indicator [symbol] 108 of the sensor unit 16 receives pressure more than the preset value. In FIG. 7B, the pointer 18 is moved in a sequence of ‘1→2’ when the indicator [symbol] 108 of the sensor unit 16 receives pressure less than the preset value.

A time required to move the pointer 18 in a sequence of ‘1→*’ in FIG. 7A is the same as a time required to move the pointer 18 in a sequence of ‘1→2’ in FIG. 7B. That is, the pointer 18 of FIG. 7A moves three times farther than the pointer 18 of FIG. 7B.

Even though the movement distance of the pointer 18 of FIG. 7A is three times as much as that of the pointer 18 of FIG. 7B, the user may feel that the pointer 18 of FIG. 7A is moved faster than the pointer 18 of FIG. 7B because the pointers 18 of FIG. 7A and FIG. 7B are moved for a same period of time. That is, when the pressure applied is more than the preset value to the sensor unit 16, the user may have a feeling that the speed of the movement of the pointer is faster than when the pressure is less than the preset value.

While FIGS. 7A-7B illustrate the case where the movement distance of the pointer 18 is lengthened when the pressure of the user input is more than the preset value, it is also possible to lengthen, similarly to the case of FIG. 7A, the movement distance of the pointer 18 by keeping the user input continuing for more than a preset time despite the fact that the pressure is less than the preset value. While the movement distance of the pointer 18 of FIG. 7A is illustrated as being three times farther than that of FIG. 7B, it can be also easily changed by those skilled in the art.

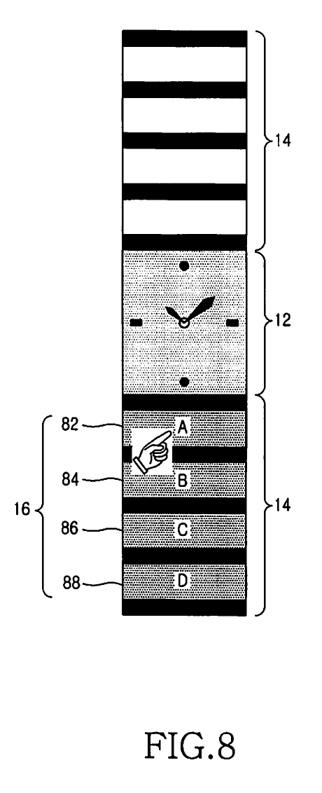

FIG. 8 is a view of a sensor unit assigned to hot keys of the wristwatch-type mobile terminal according to an embodiment of the present invention.

The strap 14 associated with the body 12 of the mobile terminal 10 is provided with the sensor unit 16, which may include at least one sensor 82, 84, 86 and 88. Also, each of the sensors 82, 84, 86 and 88 may be assigned to a hot key which performs individual function.

For example, suppose that a symbol ‘A’ 82 is assigned to call connection, a symbol ‘B’ 84 is assigned to editing of a text message, a symbol ‘C’ 86 is assigned to a Bluetooth menu, and a symbol ‘D’ 88 is assigned to an MP3 player, respectively. When a user input to ‘B’ 84 among the sensor unit 16 is received, the mobile terminal 10 displays a window for editing a text message on the display unit 28. Similarly, when a user input is received in ‘D’ 88, the mobile terminal 10 performs conversion into a multimedia mode while displaying the MP3 player on the display unit 28.

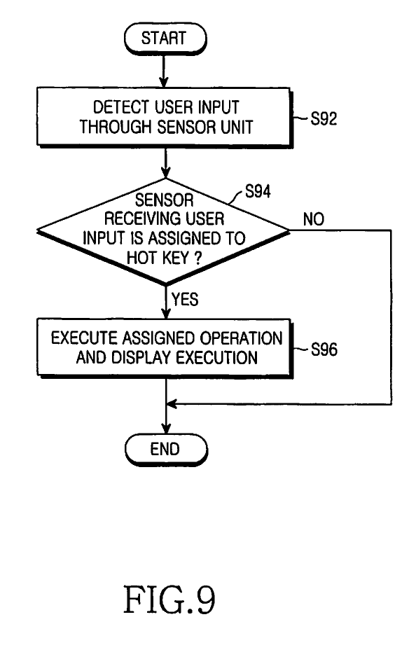

FIG. 9 is a flowchart illustrating a method for receiving user inputs in the sensor unit assigned to hot keys of the wristwatch-type mobile terminal according to an embodiment of the present invention.

The mobile terminal 10 detects a user input through the sensor unit 16 in step S92. The controller 30 determines if a sensor receiving the user input is assigned to a hot key in step S94. The wristwatch-type mobile terminal 10 has, in the strap 14 associated with the body 12, the sensor unit 16 including at least one sensor, so it can receive user inputs.

If the sensor receiving the user input is assigned to a hot key in step S94, the mobile terminal 10 performs an operation corresponding to the hot key and displays that on the display unit 28 in step S96. As a result of the determination in step S94, when the sensor is not assigned to any hot keys in step S94, the mobile terminal finishes the corresponding operations.

While the invention has been shown and described with reference to certain preferred embodiments thereof, it will be understood by those skilled in the art that various changes in form and details may be made therein without departing from the spirit and scope of the invention as defined by the appended claims. Accordingly, the scope of the present invention is not limited to the embodiments described above but is defined by the appended claim and equivalents thereof.

What is claimed is:

1. A method for receiving user inputs in a wristwatch-type mobile terminal, the method comprising the steps of:
providing a sensor unit to the wristwatch-type mobile terminal and detecting a user input through the sensor unit;
deciding an operation corresponding to a corresponding location of the sensor unit depending on the user input;
determining whether the decided operation relates to movement of a pointer movable on a display screen;
determining whether pressure of the user input is more than a preset value when the decided operation relates to the movement of the pointer; and
moving the pointer a first distance and displaying the pointer when the pressure of the user input is not more than the preset value.

2. The method as claimed in claim 1, further comprising, when the pressure of the user input is more than the preset value, moving the pointer a second distance and displaying the pointer.

3. The method as claimed in claim 2, wherein the movement of the pointer is performed such that the first and the second distances are performed for a same period of time.

4. The method as claimed in claim 1, further comprising, when the decided operation does not relate to the movement of the pointer, performing the decided operation.

5. The method as claimed in claim 1, wherein the sensor unit includes a pressure sensor.

6. The method as claimed in claim 5, wherein the pressure sensor is a capacitor, and wherein the sensor unit detects the user input when capacity of the capacitor is increased due to the user input.

7. A method for receiving user inputs in a wristwatch-type mobile terminal, the method comprising the steps of:
providing a sensor unit including at least one sensor to the wristwatch-type mobile terminal and detecting a user input through one of the at least one sensor;
determining whether a sensor receiving the user input is assigned to a hot key; and
performing an operation assigned to the hot key when the sensor receiving the user input is assigned to the hot key.

8. The method as claimed in claim 7, wherein the at least one sensor of the sensor unit includes a pressure sensor.

9. The method as claimed in claim 8, wherein the pressure sensor is a capacitor, and wherein the sensor unit detects the user input when capacity of the capacitor is increased due to the user input.

10. The method as claimed in claim 7, wherein the step of performing the operation comprises executing and displaying an execution mode corresponding to the hot key.

11. A wristwatch-type mobile terminal, comprising:
a sensor unit disposed on a strap associated with a body of the mobile terminal and including at least one sensor, the sensor unit capable of receiving a user input; and
a controller deciding an operation corresponding to a corresponding location of the sensor unit depending on the user input, and executing the decided operation.

12. The wristwatch-type mobile terminal as claimed in claim 11, further comprising a display unit displaying execution of the decided operation.

13. The wristwatch-type mobile terminal as claimed in claim 12, wherein, when the decided operation relates to movement of a pointer, the controller determines whether pressure of the user input detected through the sensor unit is a preset value and controls the display unit to move the pointer a first distance when the pressure is not more than the preset value.

14. The wristwatch-type mobile terminal as claimed in claim 12, wherein, when the decided operation relates to movement of a pointer, the controller determines whether pressure of the user input detected through the sensor unit is a preset value and controls the display unit to move the pointer a second distance when the pressure is more than the preset value.

15. The wristwatch-type mobile terminal as claimed in claim 11, wherein the sensor unit includes a pressure sensor.

16. The wristwatch-type mobile terminal as claimed in claim 15, wherein the pressure sensor is a capacitor, wherein the sensor unit detects the user input when capacity of the capacitor is increased due to the user input.
